(19) United States
(12) Patent Application Publication
(10) Pub. No.: US 2017/0311734 A1
(43) Pub. Date: Nov. 2, 2017

(54) System and Apparatus for Front-Facing Products

(71) Applicant: Wal-Mart Stores, Inc., Bentonville, AR (US)

(72) Inventors: Robert J. Taylor, Rogers, AR (US); Jeffrey S. Cruz, Bentonville, AR (US); Matthew D. Alexander, Rogers, AR (US); Marc A. Fletter, Bentonville, AR (US)

(21) Appl. No.: 15/497,793

(22) Filed: Apr. 26, 2017

Related U.S. Application Data
(60) Provisional application No. 62/329,813, filed on Apr. 29, 2016.

(51) Int. Cl. A47F 1/12; B65G 1/06; A47F 5/00

(52) U.S. Cl. CPC A47F 1/125; A47F 5/0018; B65G 1/06

(57) ABSTRACT

In some embodiments, apparatuses, systems, and methods are provided herein for front-facing merchandise in a shopping facility. A system for front-facing products includes a product display surface having a customer-facing portion, wherein a plurality of products are positioned on the product display surface, a control unit, and a product movement unit coupled to and under control of the control unit, wherein the product movement unit is configured to provide a force sufficient to induce movement of at least one product relative to the product display surface, the product display surface being substantially stationary during the movement, wherein the movement is in a direction toward the customer-facing position, and wherein the control unit is configured to receive a signal instructing activation of the product movement unit and output an activation signal to the product movement unit.

### CROSS-REFERENCE TO RELATED APPLICATION

This application claims the benefit of U.S. Provisional Application No. 62/329,813, filed Apr. 29, 2016, which is incorporated herein by reference in its entirety

### TECHNICAL FIELD

This invention relates generally to systems and apparatuses for front-facing merchandise in a shopping facility.

### BACKGROUND

Most shopping facilities include product display units (e.g., shelves, baskets, hangers, etc.) that hold and present products to shoppers. It is important to ensure that the products are properly presented on the product display units.

### BRIEF DESCRIPTION OF THE DRAWINGS

Disclosed herein are embodiments of systems, apparatuses, and methods pertaining to systems and apparatuses for front-facing merchandise in a shopping facility. This description includes drawings, wherein:

FIG. 1 depicts a product display unit 100, according to some embodiments.

FIG. 2 depicts an exploded view 204 of a product display unit 200, according to some embodiments.

FIG. 3 is a block diagram of a system 300 for front-facing products manually, according to some embodiments.

FIG. 4 is a block diagram of a system 400 for front-facing products automatically and semi-automatically, according to some embodiments.

FIG. 5 is a flow chart depicting example operations for front-facing products, according to some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses, and methods are provided herein that are useful for front-facing merchandise in a shopping facility. In some embodiments, a system for front-facing products in a shopping facility comprises a product display surface having a customer-facing portion, wherein a plurality of products are positioned on the product display surface, a control unit, and a product movement unit. The product movement unit is coupled to, and under control of, the control unit, wherein the product movement unit is configured to provide a force sufficient to induce movement of at least one product relative to the product display surface, the product display surface being substantially stationary during the movement, wherein the movement is in a direction toward the customer-facing portion. The control unit is configured to receive a signal instructing activation of the product movement unit and output an activation signal to the product movement unit.

Proper placement of products within a product display unit not only facilitates ease of shopping for guests of a shopping facility, but can also increase sales. For example, if a product is placed at the front of its product display (i.e., the product is “front-faced”), guests can more easily locate the product. Additionally, if the product is properly front-faced, guests are more likely to notice, and possibly purchase, the product. Consequently, many shopping facilities seek to ensure that products in the shopping facility are properly presented within their product display units. Embodiments of the inventive subject matter include systems, methods, and apparatuses that aid in front-facing products on a product display unit.

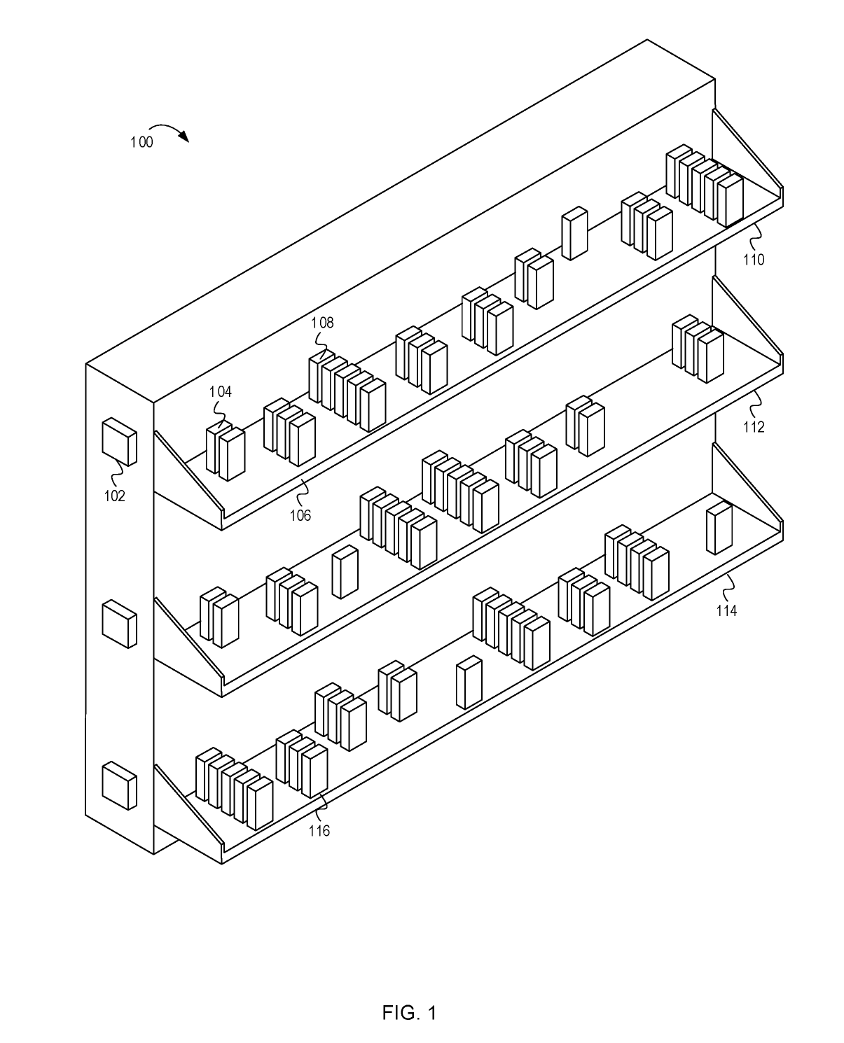

FIG. 1 depicts a product display unit 100, according to some embodiments. The product display unit 100 includes three shelves: a first shelf 110, a second shelf 112, and a third shelf 114. Although the product display unit 100 depicted in FIG. 1 includes three shelves, embodiments are not so limited (i.e., a product display unit can include any suitable number of shelves). Additionally, in some embodiments, the product display unit 100 can include presentation structures other than shelves, such as hangers, bins, etc. Each shelf includes products 116. Although the products depicted in FIG. 1 are all similarly shaped boxes, the three shelves can include any variety of products in any type(s) of packaging, if any. As previously discussed, it may be beneficial to have products front-faced for a variety of reasons. When products are properly front-faced, the products are placed at the front (i.e., a customer facing portion) of the product display unit 100. For example, a first group of products 108 is properly front faced, as the first product of the first group of products 108 is positioned near the leading edge 106 of the first shelf 110. A second group of products 104 is not properly front-faced, as the first product in the second group of products 104 is not near the leading edge 106 of the first shelf 110.

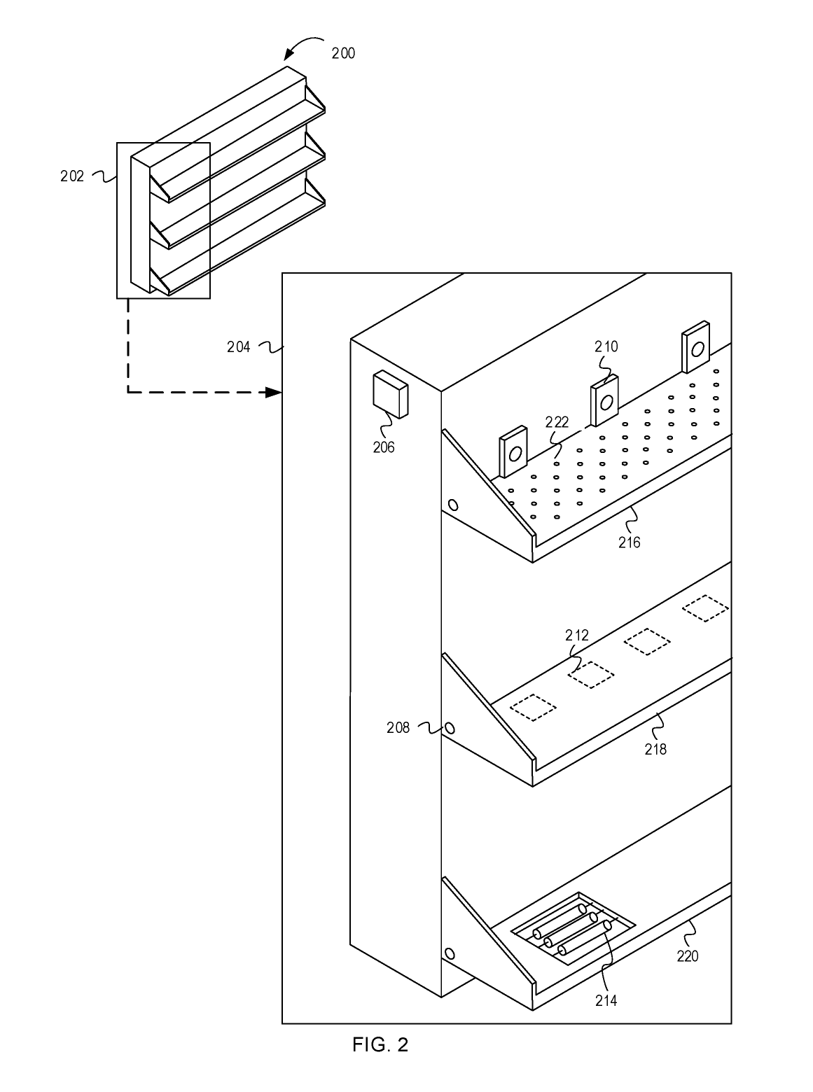

In some embodiments, one or more of the three shelves are inclined, with the rear of the shelf being higher than the front of the shelf. Such a configuration urges the products to the front of the shelf via the attractive forces of Earth's gravitational pull. However, the incline of the shelves may not be sufficient to maintain the products in a front-faced position. Additionally, shelves that are not inclined may not maintain the products in a front-faced position. Embodiments of the inventive subject matter include one or more product movement units that help urge products (as shown in, and described in more detail with reference to, FIG. 2) to the front of the shelf. The use of product movement units can decrease (or obviate the need for an) an incline of the shelves while maintaining product in a front-faced position. This may allow for a greater number of shelves, and a greater number of products, to be included on a product display unit. The product movement units can be coupled to one or more control units 102. For example, the product display unit depicted in FIG. 1 includes a control unit 102 for each of the three shelves. The control units 102 can receive signals instructing activation of the product movement units. In response to receiving the signal instructing activation of the product movement units, the control units 102 can output activation signals to the product movement units. The product movement units then urge the one or more of the products 116 to front-facing positions on the shelves.

While FIG. 1 depicts a product display unit including a plurality of products 116, FIG. 2, is an exploded view of a product display unit including a variety of product movement units.

FIG. 2 depicts an exploded view 204 of a product display unit 200, according to some embodiments. The product display unit 200 includes three shelves: a first shelf 216, a second shelf 218, and a third shelf 220. In some embodiments, one or more of the shelves can be inclined. The product display unit 200 also includes a variety of product movement units. As depicted in FIG. 2, the first shelf 216 includes a first product movement unit 210, the second shelf 218 includes a second product movement unit 212, and the third shelf 220 includes a third product movement unit 214. Although the example product display unit depicted in FIG. 2 includes a product movement unit(s) for each shelf, embodiments are not so limited. Additionally, although the example product display unit 200 depicted in FIG. 2 includes a different type of product movement unit for each shelf, embodiments are not so limited.

The first product movement unit 210 is a first style of an air supply type product movement unit. The first product movement unit 210 is positioned behind one or more rows of products on the first shelf 216. The first product movement unit 210 urges product to a front-facing position by providing air flow (e.g., a burst, continuous stream, or semi-continuous stream of air) to products on the first shelf 216. In some embodiments in addition to, or in lieu of, the first style of an air supply type product movement unit, the first shelf 216 can include a second style of an air supply product movement unit. The second style of an air supply product movement unit is the array of air supply features 222. Each air supply feature in the array of air supply features 222 can provide air flow (e.g., a burst, continuous stream, or semi-continuous stream) beneath the products on the first shelf 216. In some embodiments, the array of air supply features 222 provides an air flow sufficient to slightly lift the products on the first shelf 216 and/or reduce the coefficient of static friction between the products on the first shelf 216 and a surface of the first shelf 216. Accordingly, the second style of an air supply type product movement unit can be useful in front-facing lightweight products. Whether one or both of the first and second style of air supply type product movement units are used, the product display unit 200 includes the pneumatic components necessary to provide the air flow. For example, the pneumatic components can include tubing, compressors, valves, etc. that are connected to the first product movement unit 210. In some embodiments, a single compressor can be connected to all product display units in a shopping facility that include air supply type product movement units. In such embodiments, each product movement unit can include one or more valves and/or controllers that actuate the product movement units. For example, each product movement unit can include a valve and be independently controllable, a group (e.g., all product movement units on a shelf, a section of a shelf, or a group of shelves) can include a valve and be controllable as a group, or an entire product display can include a valve such that the product display is controllable as a unit. Additionally, although FIG. 2 depicts the first shelf 216 as including both the first style of an air supply type product movement unit and the second style of an air supply type product movement unit, a shelf may include either the first style or second style of an air supply type product movement unit.

The second product movement unit 212 is a vibration mechanism. The second product movement unit 212 can be mounted underneath the second shelf 218 (as depicted in FIG. 2), on top of the shelf, or in any other suitable location on the product display unit 200. Upon reception of an activation signal, the second product movement unit provides a mechanical vibration to the second shelf 218, or a portion of the second shelf 218. The mechanical vibration is sufficient to urge one or more products on the second shelf 218 to a front-facing position. The second shelf 218 depicted in FIG. 2 includes multiple vibration mechanisms, for example, one vibration mechanism per row of products. However, in some embodiments, several rows of products, or an entire shelf, may each have an associated vibration mechanism. In some embodiments, each of the vibration mechanisms can be controlled independently or a group of the vibration mechanisms can be controlled independently (e.g., multiple vibration mechanisms on one shelf, all vibration mechanisms on one shelf, all vibration mechanisms on a product display unit, etc.). Additionally, in some embodiments, one or more of the shelves can include manual activation mechanisms (e.g., buttons, levers, switches, etc.). Such manual activation mechanism can be mechanically or electronically controlled. For example, as depicted in FIG. 2, the second shelf 218 includes a button 208. Pushing the button 208 causes an activation signal to be sent to one or more of the vibration mechanisms.

The third product movement unit 214 includes a set of one or more powered rollers. For example, as depicted in FIG. 2, the third product movement unit 214 can include three powered rollers. The third shelf 220 can include any suitable number of product movement units. For example, each row of products, one or more rows of products, or an entire shelf can each include a set of powered rollers. Upon receipt of an activation signal, the powered rollers rotate to urge product to a front-facing position.

The product display unit 200 also includes a control unit 206. The control unit 206 can receive signals instructing activation of one or more of the product movement units. The control unit 206, upon receipt of the signals instructing activation of the product movement units, can output an activation signal to the appropriate product movement units. The product display unit 200 can include any suitable number of control units 206. For example, as depicted in FIG. 2, the product display unit 200 can include a single control unit 206 that receives signals instructing activation for, and outputs activation signals to, all product movement units on the product display unit 200. Alternatively, each section of the product display unit 200 (e.g., a shelf, section of a shelf, etc.), each product movement unit, or each type of product movement unit on the product display unit 200 can have an associated control unit 206. In embodiments that includes both a control unit 206 and a manual activation mechanism, utilization of the manual activation mechanism can cause a signal instructing activation of the product movement unit to the control unit 206. Alternatively, utilization of the manual activation mechanism can transmit a signal instructing activation of the product movement unit from the manual activation mechanism to the product movement unit. In embodiments having only a manual activation mechanism, the manual activation mechanism acts as the control unit. As one example, the manual activation unit can be a lever that is rotatable by hand. In such an embodiment, rotation of the lever would cause activation of the product movement unit.

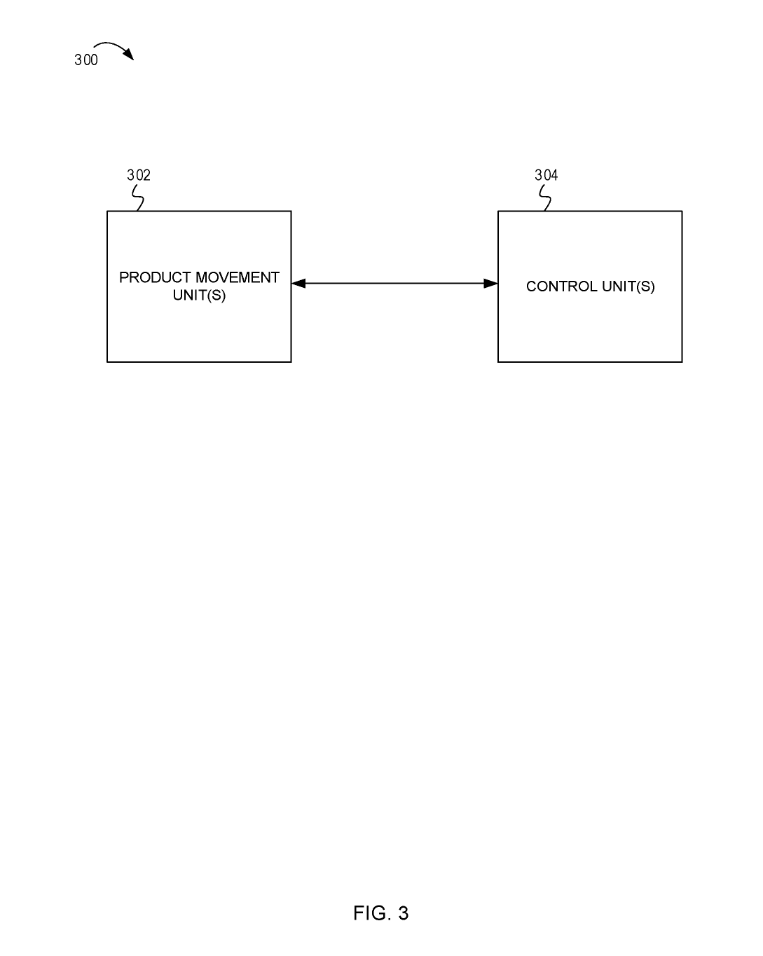

While FIG. 2 depicts an exploded view of a product display unit including a variety of product movement units, FIG. 3 depicts an example system for front-facing products manually.

FIG. 3 is a block diagram of a system 300 for front-facing products manually, according to some embodiments. The system 300 includes a product movement unit 302 and a control unit 304. The system 300 can include one or more product movement units and one or more control units 304. Additionally, the product movement unit 302 can be any type of product movement (e.g., those discussed above or any other suitable type). The control unit 304 acts to receive a signal instructing activation of the product movement unit. In the system 300 depicted in FIG. 3, the control unit receives a signal manually. For example, the control unit 304 can receive the signal instructing activation of the product movement unit from a manual activation mechanism. The manual activation mechanism can be a trigger, such as a button or lever, that an employee of the shopping center can manipulate. For example, the employee may notice that products on a product display unit are not in a front-facing position. Instead of having to adjust all of the products by hand, the employee can manipulate the manual activation mechanism. Manipulation of the manual activation mechanism can cause the control unit 304 to output an activation signal to the product movement unit 302. In embodiments in which the manual activation mechanism is the control unit 304, the manual activation mechanism can output the activation signal to the product movement unit. In embodiments in which the control unit 304 is separate from the manual activation unit, the manual activation unit can transmit the signal instructing activation of the product movement unit 302. Additionally, the product display unit can include one or more indicators that alert an employee that one or more of the products are not in a front-facing position. The indicators can include a light, a sign, a noise emitter, etc. For example, an employee may notice that an indicator is illuminated and the manipulate the manual activation mechanism.

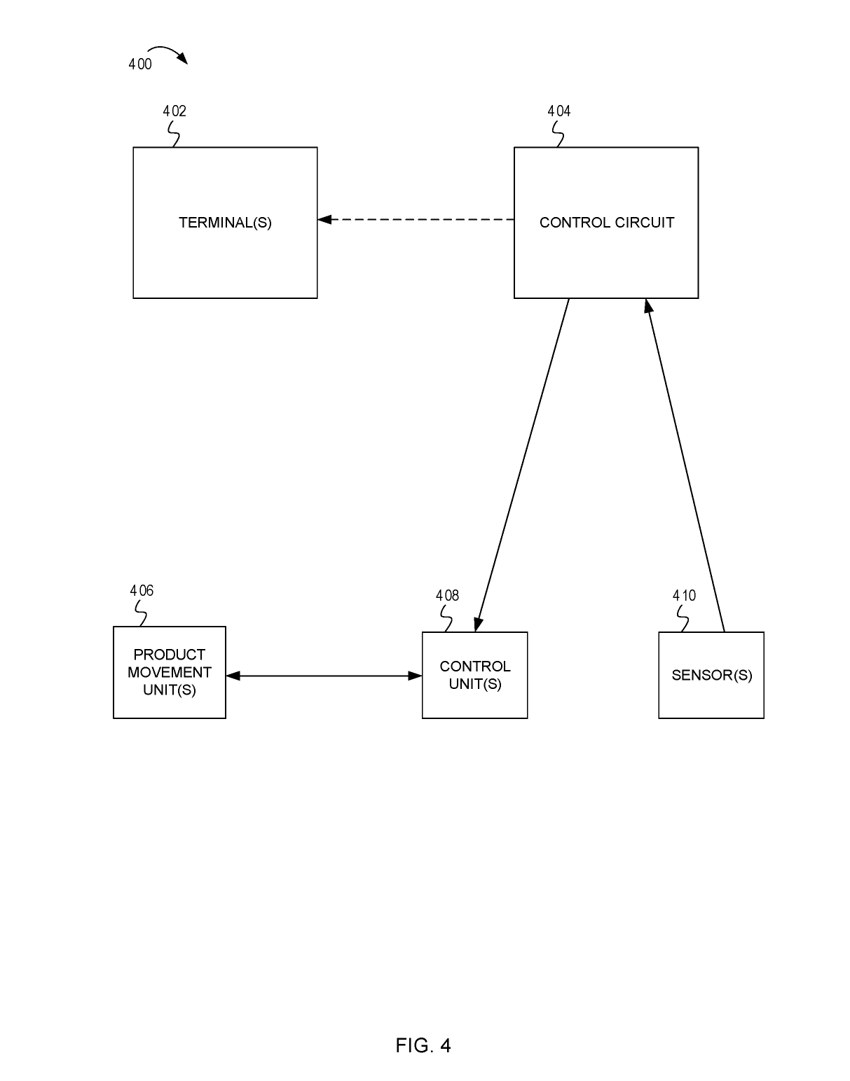

While FIG. 3 depicts an example system for front-facing products manually, FIG. 4 depicts a system for front-facing products automatically and semi-automatically.

FIG. 4 is a block diagram of a system 400 for front-facing products automatically and semi-automatically, according to some embodiments. The system 400 includes a control circuit 404, one or more sensors 410, one or more control units 408, and one or more product movement units 406. The sensors 410 send data to the control circuit 404 (e.g., via a communications network). The sensors can be any type of sensor suitable for detecting that products are not front-faced. For example, the sensors 410 can include levers, optical sensors, motion sensors, weight sensors, etc. The control circuit 404 processes the data and determines whether product associated with the sensors 410 is front-faced. For example, in the case of optical sensors, the data can include light values or other images from the product display unit. If the light level or image indicates that the products are not front-faced (e.g. the light level is above a threshold or the image does not depict a product within a predetermined distance), the control circuit 404 transmits a signal (e.g., via the communications network) instructing activation of the product movement unit 406. In embodiments including a lever (e.g., positioned at the leading edge of a shelf), removal of a product from the product display unit may cause the lever to move or be displaced. Movement of the lever indicates that a product was removed from the shelf and an indication that a product was removed is transmitted to the control circuit 404. The control unit 408 receives the signal instructing activation of the product movement unit 406 and outputs an activation signal to the product movement unit 406. In some embodiments, the control unit 404 can also determine which sensor 410 transmitted the data (e.g., the data can include an indication of the sensor 410 from which it originates). In such embodiments, the control unit 404 can transmit the signal instructing activation of the product movement unit 406 to a specific control unit 408 that is associated with the product that is not front-faced. Alternatively, the control circuit 404 can transmit the signal instructing activation of the product movement unit 406 to all of the control units 408 and the control units 408 can determine which product movement unit 406 to output the activation signal to the appropriate product movement unit(s) 406.

In some embodiments, the sensors 410 also send data to the control circuit 404 after activation of the product movement units 406. The control circuit 404 processes the data and determines whether product associated with the sensors 410 is front-faced. Because the product movement units 406 have already been activated, the products should be front-faced. If the products are not front-faced, the control circuit 404 can transmit an indication to the terminal 402 that further action should be taken. For example, if an inventory management system indicates that additional product is located in the stockroom, the action can be a replenishment action. If the inventory management system indicates that there is no additional product in the stockroom, the action can be the generation of an order for more product. Additionally, the action can be an investigatory action instructing an employee to determine why the product is not front-faced after activation of the product movement units 406.

The control circuit 404 can also transmit the signal instructing activation of the product movement units 406 based on triggers other than, or in addition to, the data sent by the sensors 410. For example, the control circuit 404 can transmit the signal instructing activation of the product movement units 406 based on item information (e.g., department, category, aisle locations, etc.), store inventory information (e.g., on-hand, shelf capacity, feature flag, deleted status, etc.), availability information (sales, ROS, scanned outs, lost sales, etc.), planning information (e.g., planning selections, new/not year on modular, future feature set date, etc.), staffing information, task management information, or any other relevant information.

As an example, the control circuit 404 can transmit the signal instructing activation of the product movement units 406 based on deliveries and/or delivery schedules. When a delivery of products arrives, the products are taken to a sales area of the shopping facility to be stocked. During stocking, products on a product display unit as well as products being added to the product display unit may be moved, resulting in products that are not front-faced. The control circuit 404 can transmit the signal instructing activation of the product movement units 406 after the stocking is complete (e.g., based on a completion indication, a time of expected completion, etc.).

As another example, the control circuit 404 can transmit the signal instructing activation of the product movement units 406 based on availability metrics. One example of an availability metric is lost sales. Lost sales occur when actual sales fall below sales predictions for a product. Actual sales can fall below sales predictions when products are not properly zoned, as customers may not see the products if they are not front-facing and thus not purchase the products. The control circuit 404 can transmit the signal instructing activation of the product movement units 406 when lost sales are detected. Another example of an availability metric is a “nil pick.” A nil pick can occur when an employee is collecting products from a shopping facility on behalf of a customer and the employee believes the item to be out of stock. The employee notes the out of stock item as a nil pick. In some cases, the product is not out of stock. Rather, the employee may not have seen the product because it was not properly front-faced. Consequently, nil picks may indicate that products are not properly front-faced in the shopping facility. The control circuit 404 can transmit the signal instructing activation of the product movement units 406 based on indications of nil picks.

As another example, the control circuit 404 can transmit the signal instructing activation of the product movement units 406 based on inventory management information, such as a planogram update. Planogram updates can include repositioning, adding, or subtracting items from an assigned space in a shopping facility. After a planogram update, products may need to be front-faced. Consequently, the control circuit 404 can transmit the signal instructing activation of the product movement units 406 based on indications of planogram updates.

In some embodiments, the control circuit 404 can also transmit the signal instructing activation of the product movement unit 406 at predetermined times or intervals. For example, the control circuit 404 can transmit the signal instructing activation of the product movement unit 406 periodically throughout the day, after peak sales hours, when shopping facility traffic is high, after an elapsed time, or based on OSCA or inventory management data. Additionally, the control circuit 404 can transmit the signal instructing activation of the product movement unit 406 based on data relating to products and the sale of products. For example, the control circuit 404 can be aware of and/or track sales data for products in the shopping facility. After a predetermined number of sales for a product, the control circuit 404 can transmit the signal instructing activation of the product movement unit 406 associated with that product. Alternatively, transmission of the signal instructing activation of the product movement unit 406 can be based on expected, anticipated, and/or historical sales.

In a semi-automated embodiment, the system 400 can also include one or more terminals 402. The terminals can be located throughout a shopping facility or carried by employees. When the control circuit 404 determines that products are not front-faced (or that products should be front-faced based on timing and/or sales data), the control circuit 404 can transmit a signal to one or more of the terminals 402 indicating that the products are should be front-faced. The signal can also include a location of the products, or the product display unit, on which the products are located. In response to receiving the signal, the terminal 402 can present an indication that the products are not front-faced and a location of the products. In some embodiments, the control circuit 404 can determine locations of employees and/or terminals 402 and transmit the signal to one or more terminals 402 based on the employees and/or the terminals. The employee can then provide a physical input at a manual control to activate the product movement unit 406.

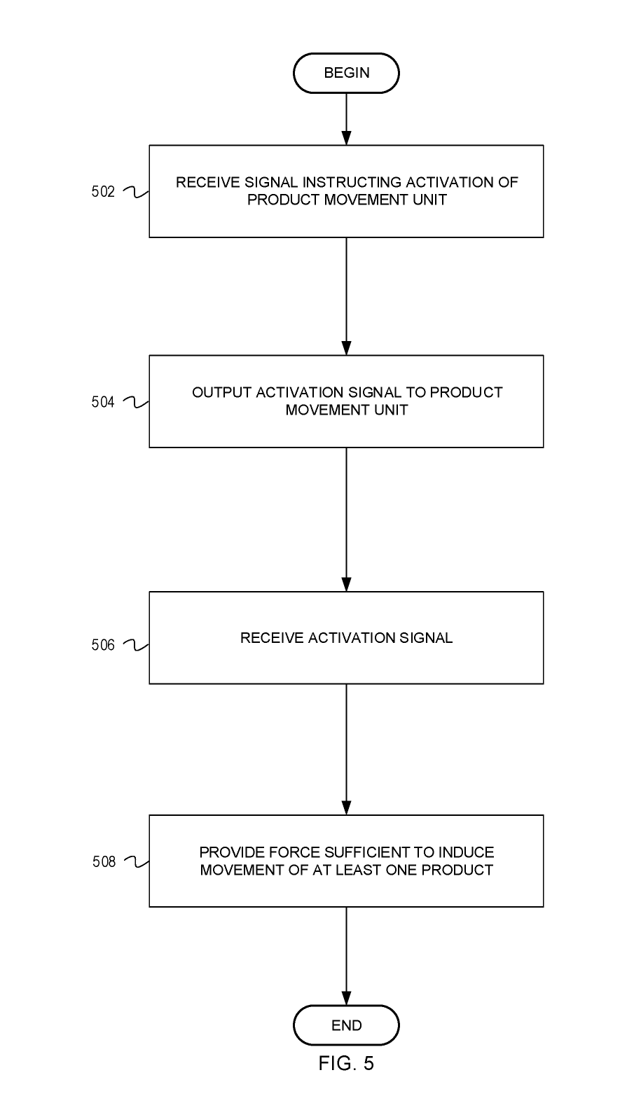

While FIG. 4 depicts a system for front-facing products automatically and semi-automatically, FIG. 5 is a flow chart depicting example operations of a system for front-facing products.

FIG. 5 is a flow chart depicting example operations for front-facing products, according to some embodiments. The flow begins at block 502.

At block 502, a signal instructing activation of a product movement unit is received. The signal can be specific to a single product movement unit or a group of product movement units. In an automated embodiment, a control circuit can transmit the signal instructing activation of the product movement unit to a control unit. In a semi-automated embodiment, the control circuit can transmit the signal instructing activation of the product movement unit to one or more terminals. In a manual embodiment, the signal instructing activation of the product movement unit can be manipulation of a manual activation mechanism. For example, an employee could manipulate a rocker switch. The flow continues at block 504.

At block 504, an activation signal is outputted to the product movement unit. For example, the control unit can output the activation signal. In some embodiments, the control unit process the signal instructing activation of the product movement unit to determine if the signal instructing activation of the product movement is intended for that specific control unit and/or with which product movement unit the signal instructing activation of the product movement unit is associated. In such embodiments, the control unit outputs the activation signal to the appropriate product movement unit. In some embodiments, the activation signal is an electronic signal (e.g., a digital signal or an analog signal). For example, a manipulation of a button or rocker switch may complete a circuit and the activation signal is the flow of current. In the case of an automated system, the signal can instruct a motor to open a valve, power a vibration mechanism, power a roller, etc. Alternatively, the activation signal can be a mechanical signal. For example, the control unit can be a mechanical device that transmits a mechanical signal, such as a hand crank causing gears to rotate. The flow continues at block 506.

At block 506, the activation signal is received. For example, the product movement unit can receive the activation signal. In some embodiments, the product movement unit can include logic to determine if the activation signal is intended for that product movement unit. If the activation signal is not intended for that product movement unit, that product movement unit will not activate. The flow continues at block 508.

At block 508, a force sufficient to induce movement of at least one product is provided. For example, the product movement unit can provide the force. In embodiments including a vibration mechanism, vibration of the vibration mechanism provides the force sufficient to induce movement of at least one product. In embodiments including an air supply type product movement unit, air expelled from the air supply type product movement unit provides the force sufficient to induce movement of at least one product. In embodiments including powered rollers, movement of the powered rollers provides the force sufficient to induce movement of at least one product. In some embodiments, the product movement unit provides the force for a predetermined time. In other embodiments, the product movement unit provides the force until it receives a deactivation signal from the control unit. For example, a sensor can be used to determine that one or more products are not front-faced. When it is determined that the products are front faced (e.g., by the control circuit, control unit, and/or sensor), the product movement unit can stop providing the force.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept. For example, although this specification refers to products being presented to customer for sale on a sales floor (i.e., the frontend), embodiments of the inventive subject matter can be used in any environment in which ensuring that items are located at a front of a shelf (or other item support) is desirable. For example, embodiments of the invective subject matter can be used in other locations of a shopping facility (e.g., a stock room or backend) or in locations other than shopping facilities (e.g., warehouses).

Although FIG. 2 depicts each shelf of the product display unit as having a different type of product movement unit, embodiments are not so limited. For example, a single shelf could have multiple types of product movement units. The types of product movement units located on a product display unit can be selected based upon the type of product. As but one example, a first portion of a shelf can be outfitted with powered rollers for larger items, a second portion of the shelf can be outfitted with an air supply type product movement unit for lighter and/or smaller items, and a third portion of the shelf can be outfitted with a vibration mechanism for bagged products. Furthermore, the product display unit can include additional types of product movement units. For example, the product display unit can include piston type, spring type, conveyor type, or any other suitable type of product movement units.

Although FIG. 1 and FIG. 2 depict product display units that include only shelves, embodiments can be used with other types of product display units. For example, a product display unit may include, in addition to or in lieu of, shelves, suspended baskets, baskets seated on shelves, hooks for hanging products, trays, or any other device suitable for presenting products. In the same manner as described herein, products in presented in any suitable manner can be front faced via a product movement mechanism.

In some embodiments, a system for front-facing products in a shopping facility comprises a product display surface having a customer-facing portion, wherein a plurality of products are positioned on the product display surface, a control unit, and a product movement unit. The product movement unit is coupled to and under control of the control unit, wherein the product movement nit is configured to provide a force sufficient to induce movement of at least one product relative to the product display surface, the product display surface being substantially stationary during the movement, wherein the movement is in a direction toward the customer-facing portion. The control unit is configured to receive a signal instructing activation of the product movement unit and output an activation signal to the product movement unit.

In some embodiments, a method for moving a product on a product display surface toward a customer-facing position of the product display surface includes receiving, by a control unit, a signal instructing activation of a product movement unit, outputting, by the control unit, an activation signal to the product movement unit, receiving, at the product movement unit, the activation signal, and in response to receiving the activation signal, providing, by the product movement unit, a force sufficient to induce movement of at least one product relative to the product display surface, the product display surface being substantially stationary during the movement, wherein the movement is in a direction toward the customer-facing position.

What is claimed is:

1. A system in a shopping facility, the system comprising:
a product display surface having a customer-facing portion, wherein a plurality of products are positioned on the product display surface;
a control unit;
a product movement unit coupled to and under control of the control unit, wherein the product movement unit is configured to provide a force sufficient to induce movement of at least one product relative to the product display surface, the product display surface being substantially stationary during the movement, wherein the movement is in a direction toward the customer-facing portion; and
wherein the control unit is configured to:
receive a signal instructing activation of the product movement unit; and
output an activation signal to the product movement unit.

2. The system of claim 1, further comprising a control circuit coupled to the control unit, wherein the control circuit is configured to determine that the at least one product is not properly positioned on the display relative to the customer facing portion.

3. The system of claim 2, wherein the control circuit is further configured to transmit, via a communications network, the signal instructing activation of the product movement unit to the control unit.

4. The system of claim 2, wherein the control circuit is further configured to transmit, via a communications network to a terminal, an indication that the at least one product is not properly positioned.

5. The system of claim 2, wherein the determination that the at least one of the products is not properly positioned on the display surface is based on one or more of OSCA data, sales data, information from a sensor, inventory management data, a current time, and an elapsed time.

6. The system of claim 1, wherein the product movement unit includes one or more of a vibration unit, an air supply unit, and powered rollers.

7. The system of claim 1, wherein the control unit is a manual control, and wherein the signal instructing activation of the product movement unit is a physical input at the manual control.

8. The system of claim 1, wherein the product movement unit is configured to continue to provide the force until the at least one product is oriented at the customer-facing portion of the product display surface.

9. The system of claim 1, wherein the at least one product includes all products on the product display surface.

10. The system of claim 1, wherein the product display surface includes one or more of rollers, a low friction surface, and an incline.

11. A method for moving a product on a product display surface in a shopping facility toward a customer-facing portion of the product display surface, the method comprising:
receiving, by a control unit, a signal instructing activation of a product movement unit;
outputting, by the control unit, an activation signal to the product movement unit;
receiving, at the product movement unit, the activation signal; and
in response to receiving the activation signal, providing, by the product movement unit, a force sufficient to induce movement of at least one product relative to the product display surface, the product display surface being substantially stationary during the movement, wherein the movement is in a direction toward the customer-facing portion.

12. The method of claim 11, further comprising:
determining, by a control circuit coupled to the control unit, that the at least one product is not properly positioned on the display relative to the customer-facing portion.

13. The method of claim 12, further comprising:
transmitting, by the control circuit via a communications network, the signal instructing activation of the product movement unit.

14. The method of claim 12, further comprising:
transmitting, by the control circuit via a communications network to a terminal, an indication that the at least one product is not properly positioned.

15. The method of claim 12, wherein the determining that the at least one of the products is not properly positioned on the display surface is based on one or more of OSCA data, sales data, information from a sensor, inventory management data, a current time, and an elapsed time.

16. The method of claim 11, wherein the product movement unit includes one or more of a vibration unit, an air supply unit, and powered rollers.

17. The method of claim 11, wherein the control unit is a manual control, and wherein the signal instructing activation of the product movement unit is a physical input at the manual control.

18. The method of claim 11, wherein the providing the force continues until the at least one product is oriented at the customer facing portion of the product display surface.

19. The method of claim 11, wherein the at least one product includes all products on the product display surface.

20. The method of claim 11, wherein the product display surface includes one or more of rollers, a low friction surface, and an incline.
